(19) United States
(12) Patent Application Publication
(10) Pub. No.: US 2002/0126471 A1
(43) Pub. Date: Sep. 12, 2002

(54) Emergency escape lighting system

(76) Inventor: Steven A. Becnel, Belle Chasse, LA (US)

Correspondence Address: BANNER & WITCOFF, 1001 G STREET N W, SUITE 1100, WASHINGTON, DC, 20001, US

(21) Appl. No.: 09/878,318

(22) Filed: Jun. 12, 2001

Related U.S. Application Data
(63) Continuation of application No. 08/805,241, filed on Feb. 24, 1997, now abandoned.

(51) Int. Cl. F21K 2/00

(52) U.S. Cl. 362/34; 206/221

(57) ABSTRACT

A chemically activated lighting system is provided which serves to clearly mark an exit door or hatch as an emergency escape route. The system utilizes two chemical agents which when mixed together form a compound which radiates light. The compound is then passed through a transparent conduit which is found around the escape exit. Each of the chemical agents which are mixed to form the chemical compound are stored in separate chambers. When the system is activated, compressed gas is released from a CO² canister which causes the chambers which contain the chemical agents to be compressed, forcing the agents out of their respective chambers and into a central mixing chamber where they are mixed and form the light producing compound. The compound is then passed through the transparent conduit in order to illuminate the escape exit.

### BACKGROUND OF THE INVENTION

The present invention generally relates to the field of emergency safety systems, and more particularly, is directed to an emergency lighting system which marks and identifies escape routes and passageways during an emergency condition in buildings, vehicles, aircraft, and watercraft.

In many emergency situations, such as fires, earthquakes and the like, occupants of a building must vacate the premises very quickly. In such situations, which usually are accompanied by confusion and chaos, the occupants may not be readily aware of emergency routes of escape. Moreover, in periods of darkness, escape routes may not be visual.

While fire safety codes require the posting of exit signs in buildings and government regulations require the similar posting of signs in common carriers, such as aircraft, trains and buses, these signs are not always adequate during an emergency situation. A major disadvantage is that such signs are usually posted many feet from the actual escape point. Thus, in darkness, the signs may be of no real use to someone trying to escape from a building.

The problem of inadequate marking of escape routes is even more severe in aircraft. For example, there is often only limited time for occupants to respond to an emergency condition in an aircraft. In addition, the occupants are usually preoccupied with overcoming the emergency, or mitigating its effects, until the craft has been stabilized or come to rest. Only then do the occupants have an opportunity, or the presence of mind, to focus on an escape route. The ability to locate an escape route quickly and exit the aircraft will often mean the difference between a successful or failed escape. Thus, an effective method for locating emergency escape routes is particularly important for aircraft.

Accordingly, there is a great need for an effective emergency lighting system which marks and identifies escape routes and passageways during an emergency condition.

### SUMMARY OF THE INVENTION

Accordingly, it is an object of the present invention to obviate the above-noted shortcomings and disadvantages of emergency escape routes and marking systems known in the prior art.

It is a further object of the present invention to provide an emergency escape marking system which can be automatically operated without user intervention.

It is a still further object of the present invention to provide an emergency escape marking system which clearly outlines the boundaries of the escape route.

It is a still further object of the present invention to provide an emergency escape route marking system which is visible in low light conditions.

It is a further object of the present invention to provide an emergency escape route marking system which is self-contained and not be reliant on outside systems for its operation.

It is a still further object of the present invention to provide an emergency escape route marking system which can be activated remotely in the event of an emergency condition.

It is also an object of the present invention to provide an emergency escape route marking system which is low in cost to manufacture and can be readily installed adjacent existing emergency escape routes.

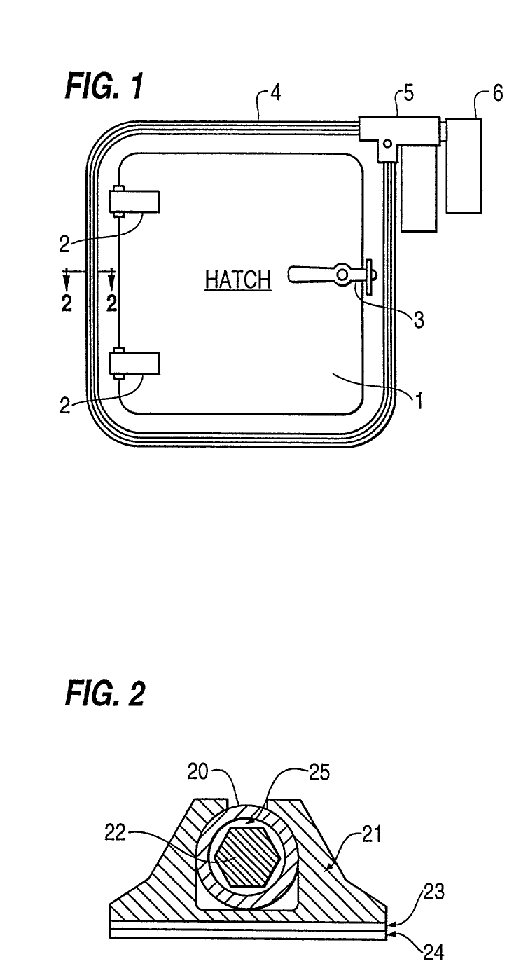

FIG. 2 is a cross-sectional view of the emergency escape lighting system of applicant's invention take along line A-A in FIG. 1;

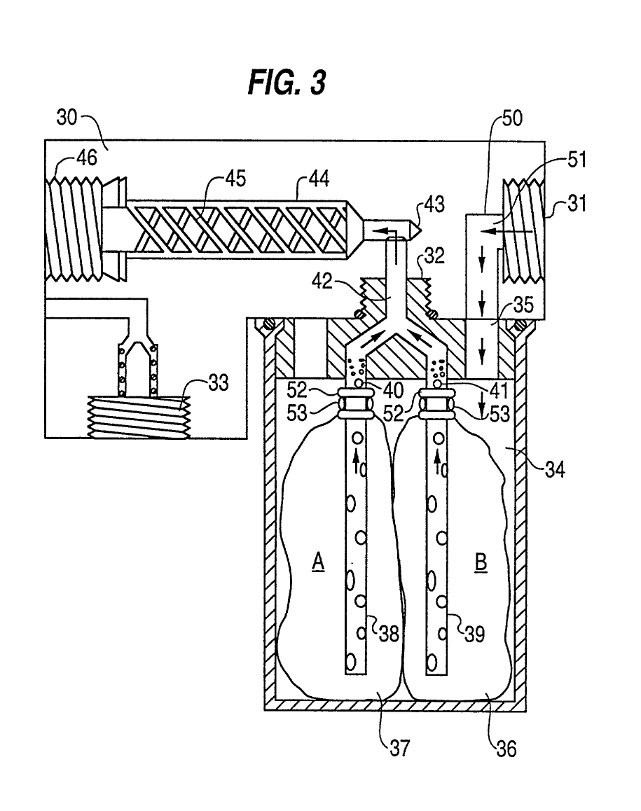

FIG. 3 is an assembly and cross-sectional view of the chemical storage and mixing assembly which forms a part of the emergency escape lighting system in accordance with applicant's invention;

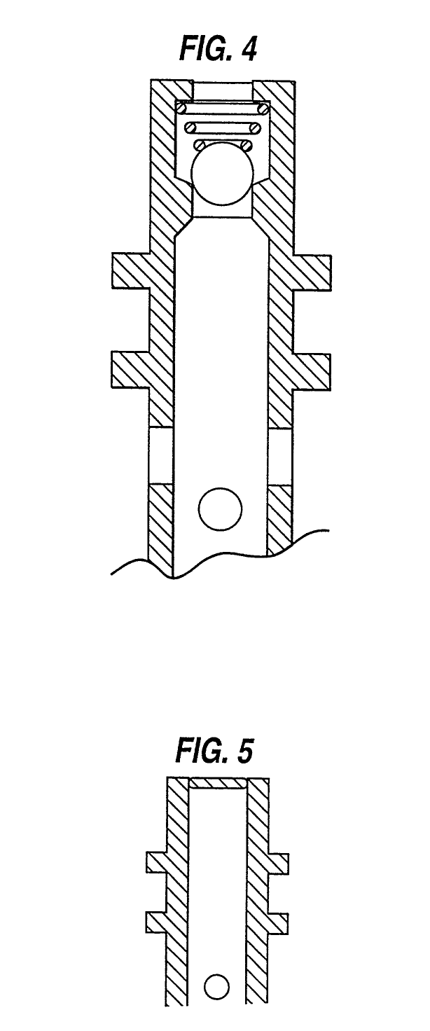

FIG. 4 is a cross-sectional view of the perforated tube and check valves shown in FIG. 3;

FIG. 5 is a cross-sectional view of another embodiment of the perforated tube shown in FIG. 4;

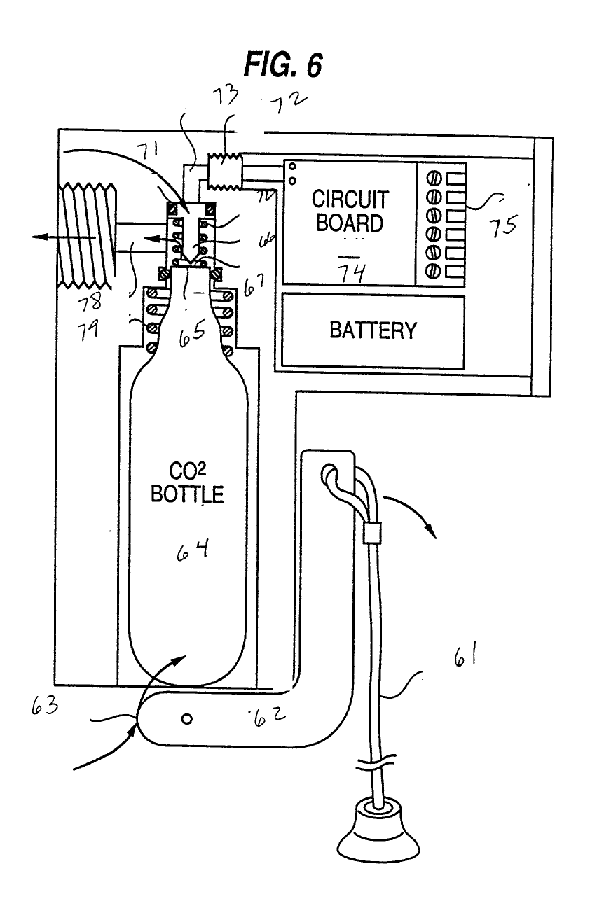

FIG. 6 is an assembly and cross-sectional view of the system actuation assembly which forms a part of the emergency escape lighting system in accordance with Applicant's invention; and

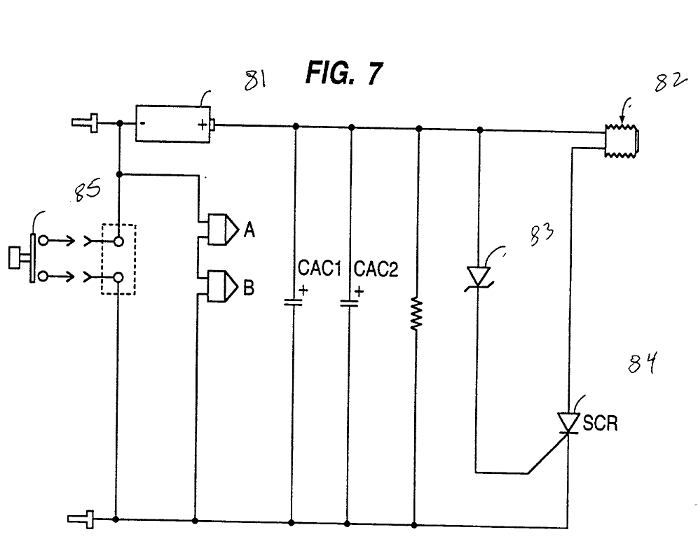

FIG. 7 is a schematic diagram of the electronic activation circuitry for the emergency escape lighting system in accordance with Applicant's invention.

### BRIEF DESCRIPTION OF THE PREFERRED EMBODIMENT

A preferred embodiment of the present invention will now be described with reference to the accompanying drawing.

FIG. 1 illustrates a hatch, or exit door 1 around which the emergency escape lighting system of the present invention is installed. Hatch 1 includes a pair of hinges 2 and a latch assembly 3. Hatch 1 and its associated hinges 2 and latch assembly 3 are conventional assemblies and are well known in the art.

The lighting system of the present invention can be broken into three subassemblies; a tube and rail assembly 4, a chemical light storage and mixing assembly 5 and a system activation assembly 6.

A cross section of tube and rail subassembly 4 is illustrated in FIG. 2. The assembly is formed of a clear plastic polyurethane tube 20 which is held in place by a clear extruded polyurethane track 21. Tube 20 has a core 22 in its center which serves two purposes: 1) it reduces the volume of chemical light required to fill the tube, and 2) it adds strength to the tube so that it does not collapse if exterior pressure is applied. As shown in FIG. 2, a cavity 25 is formed between core 22 and the inside surface of tube 20. As discussed in further detail below, a chemical light material passes through cavity 25 when the system is activated.

Rail 21 has a reflective backing 23 with a self adhesive strip 24 to assist in light radiation and installation. Backing 23 also provides support to tube 20 as it does not kink.

Chemical storage and mixing assembly 5 is illustrated in further detail in FIG. 3. The assembly is formed of a manifold 30 which includes air inlet port 31, chemical inlet port 32 and air return inlet port 33.

When air pressure from activation assembly 6, discussed below, enters air inlet port 31, it moves along a passage way 50 to chemical storage chamber 34 through port 35 as shown by arrows 51. Chamber 34 includes compressurable chemical component bags 38 and 39. Bags 36 and 37 contain chemical agents which when mixed together form a compound which radiates light as is known in the art. As pressure increases in chamber 34 due to the incoming air flow from activation system 6, it will apply pressure to chemical bags 36 and 37. This will force the chemicals up respective perforated tubes 38 and 39 through check valves 40 and 41 and into chemical inlet port 33. FIGS. 4 and 5 illustrate alternative embodiments for perforated tubes 38 and 39.

Mixing inlet port 43 diverts the chemicals into a spiral mixing chamber 44 where they will then be diverted to port 46 and injected into tube and rail system 4 as illustrated in FIG. 1.

On a closed loop system the end 47 of inlet 33 and the vent valve at the tube return inlet port will allow the air in the line to be released to the atmosphere. Due to the difference in fluid resistance of the air in the line verses the chemical, when the chemical reaches the valve it will close.

The emergency escape lighting system is designed to activate when pressure is applied to the storage and mixing manifold. The emergency activation system is designed to deliver activation pressure from a CO² cartridge.

The activation system will now be described with reference to FIG. 6. In the manually activated mode when lanyard 1 is pulled in the down position it rotates lever 2 clockwise. Lobe 3 exerts a force in the direction of arrow 4 on CO² bottle 5. As the top of the bottle 5 presses against puncture pin 6, puncture pin 6 pierces seal 7 on the bottle and releases the gas through port 8 and into the manifold. Piercing pin 6 is held in place against ridge 11 by spring 10. CO² bottle 5 is held away from pin 6 by spring 9 and rests on handle 2.

The system can also be activated by applying an electrical pulse to gas pressure cartridge 12 which will create pressure in port 13 behind puncture pin 6. This pressure will drive puncture pin 6 into the CO² bottle seal 7 and release the CO² into port 8 into the manifold.

The pulse to the gas generator 12 can be delivered by circuit card 14 or from an external source through terminal strip 15. FIG. 7 is a schematic diagram of circuit card 14. Circuit card 14 has sensors on board to fire the system if it is submerged in sea water or if it inverts as when the system is installed on a vehicle and the vehicle rolls over. Circuit card 14 also has provisions for external sensors through terminal 15 for fire, smoke, vibration and remote firing of the unit.

When the device is submerged in seawater having a conductivity of 100 u mho's or higher and the seawater bridges the gap between immersion probes A and B. Capacitor 1 and 2 begin to charge. When the voltage level of the capacitor reaches a level set by zener 3 diode a current is applied to the gate terminal of SCR 4. This allows the voltage in the capacitors to dump through gas generator 12 and thereby supply enough current to fire and generate gas to drive the piercing pin 6 into the seal of CO² bottle 5.

A push button normally open switch 20 also is provided to manually trigger the circuit. As illustrated in FIG. 7, switch 20 is connected in parallel with probes A and B, thus bypassing the probes and delivery current to capacitor 1 and 2, diodes 3 and SCR 4 as described above. A mercury tilt switch may also be connected in parallel with probe A and B to automatically trigger the system when a tilt condition is detected. The circuitry is powered by a battery 21.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

What is claimed is:

1. A system for illuminating the perimeter of an opening, said system comprising:
a light enclosure which can be positioned adjacent said opening;
a first chamber for holding a first chemical light material;
a second chamber for holding a second chemical light material;
a mixing chamber coupled to said light enclosure and to said first and second chambers for mixing said first and second chemical light materials to produce a third chemical material which radiates light, said third material being supplied to said light enclosure; and
a control device for controlling the operation of said system.

2. The system of claim 1, wherein said first and second chambers are formed of a collapsible container.

3. The system of claim 2, wherein said system further includes a squeezing device for exerting pressure on each of said collapsible containers to force said first and second chemical light material from said first and second chambers when said system is activated.

4. The system of claim 3, wherein said first and second chambers include an outlet port through which respective said first and second chemical light materials pass when pressure is exerted on said collapsible containers.

5. The system of claim 4, wherein each of said outlet ports is formed of a tube having a plurality of inlet openings and an outlet opening, wherein said first and second chemical materials enter said inlet openings and is discharged through said outlet opening to said mixing chamber.

6. The system of claim 3, wherein said squeezing device is driven by compressed gas.

7. The system of claim 2, wherein said system further includes a fluid-tight containment chamber for containing said collapsible chambers.

8. The system of claim 7, wherein said system further includes a fluid supply coupled to said containment chamber for delivering fluid to said containment chamber when said system is activated.

9. The system of claim 8, wherein said control device includes a fluid supply control valve coupled to said fluid supply for controlling the supply of fluid delivered to said containment chamber, when said system is activated said fluid supply control valve controls said fluid supply to deliver fluid to said containment chamber sufficient to exert pressure on said collapsible containers to force said first and second chemical light materials from said first and second chambers.

10. The system of claim 9, wherein said fluid is CO² gas under pressure.

11. The system of claim 10, wherein said first and second chambers includes an outlet port through which respective said first and second chemical light materials pass to said mixing chamber when pressure is exerted on said collapsible containers.

12. The system of claim 11, wherein each of said outlet ports is formed of a tube having a plurality of inlet openings and an outlet opening, wherein said first and second chemical material enter said inlet openings and is discharged through said outlet opening.

13. The system of claim 12, wherein said control device controls the operation of said fluid control valve in response to an activation signal.

14. The system of claim 2, wherein said light enclosure is formed of hollow construction to receive said third material, wherein at least one portion of said enclosure is transparent in order to allow light to be radiated from said third material through said transparent portion.

15. The system of claim 14, wherein the inside of said enclosure includes a spacing core, said third material being located between said spacing core and the interior of said light enclosure.
